(19) United States
(12) Patent Application Publication
(10) Pub. No.: US 2017/0034248 A1
(43) Pub. Date: Feb. 2, 2017

(54) File Movement Service Utility

(71) Applicant: BANK OF AMERICA CORPORATION, Charlotte, NC (US)

(72) Inventor: Peter Bals, Charlotte, NC (US)

(21) Appl. No.: 14/813,779

(22) Filed: Jul. 30, 2015

(51) Int. Cl. H04L 29/08; H04L 29/06

(52) U.S. Cl. CPC H04L 67/06; H04L 63/0428

(57) ABSTRACT

An interface receives a request for data services from a consumer, wherein the consumer comprises one of a financial institution and a credit bureau and the request for data services comprises at least one of a request for financial data and a request for metadata. A processor determines whether the request requires data publication. When the request requires data publication, the processor extracts data from one of a plurality of domains, wherein the domain stores data and metadata associated with the financial institution. The processor automatically transforms the data into a standard format. The processor automatically extracts metadata associated with the data. The processor further automatically receives the data and the metadata from the interface. A memory is communicatively coupled to the processor and is operable to automatically store the data and the metadata, wherein the data and the metadata are stored separately. The processor links the consumer with the data. The interface communicates the data to the consumer.

### TECHNICAL FIELD

This invention relates generally to data, and more particularly to data movement, tracking, and management.

### BACKGROUND

Enterprises may transfer a large amount of data to many different consumers. In traditional systems, delivery of data to each consumer may be point-to-point, resulting in extracting and transferring similar sets of data to multiple consumers. To alleviate this problem, data may be extracted from an original source and stored in a central source before being transferred to consumers.

### SUMMARY OF PREFERRED EMBODIMENTS

In accordance with the teachings of the present disclosure, disadvantages and problems associated with data movement, tracking, and management may be reduced or eliminated.

In accordance with a particular embodiment of the present disclosure, an interface receives a request for data services from a consumer, wherein the consumer comprises one of a financial institution and a credit bureau and the request for data services comprises at least one of a request for financial data and a request for metadata. A processor determines whether the request requires data publication. When the request requires data publication, the processor extracts data from one of a plurality of domains, wherein the domain stores data and metadata associated with the financial institution. The processor automatically transforms the data into a standard format. The processor automatically extracts metadata associated with the data. The processor further automatically facilitates receiving the data and the metadata. A memory is communicatively coupled to the processor and is operable to automatically store the data and the metadata, wherein the data and the metadata are stored separately. The processor links the consumer with the data. The interface communicates the data to the consumer.

In accordance with another embodiment of the present disclosure, a method, comprises: receiving, through an interface, a request for data services from a consumer, wherein the consumer comprises one of a financial institution and a credit bureau and the request for data services comprises at least one of a request for financial data and a request for metadata; determining, by a processor, whether the request requires data publication; when the request requires data publication, extracting data, by the processor, from one of a plurality of domains, wherein the domain stores data and metadata associated with the financial institution, automatically transforming, by the processor, the data into a standard format, automatically extracting, by the processor, the metadata associated with the data, automatically receiving, through the processor, the data and the metadata, and automatically storing, in a memory, the data and the metadata, wherein the data and the metadata are stored separately; linking, by the processor, the consumer with the data; and communicating, through the interface, the data to the consumer.

Certain embodiments of the present disclosure may provide one or more technical advantages. A technical advantage of one embodiment includes optimizing storage and computer resources. As another example, a technical advantage of one embodiment includes governing the use and distribution of data from an originating source to consumers. As yet another example, the system and method described herein may provide insights into the data supply chain such as for control purposes and/or data supply chain transparency.

Other technical advantages of the present disclosure will be readily apparent to one skilled in the art from the following figures, descriptions, and claims. Moreover, while examples of specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates a system for a file movement service;

FIG. 2 illustrates an example graphical user interface for facilitating a file movement service;

FIG. 3 illustrates an example method for providing data services to consumers; and

FIG. 4 illustrates an example method for extracting data.

### DETAILED DESCRIPTION OF THE PREFERRED EMBODIMENTS

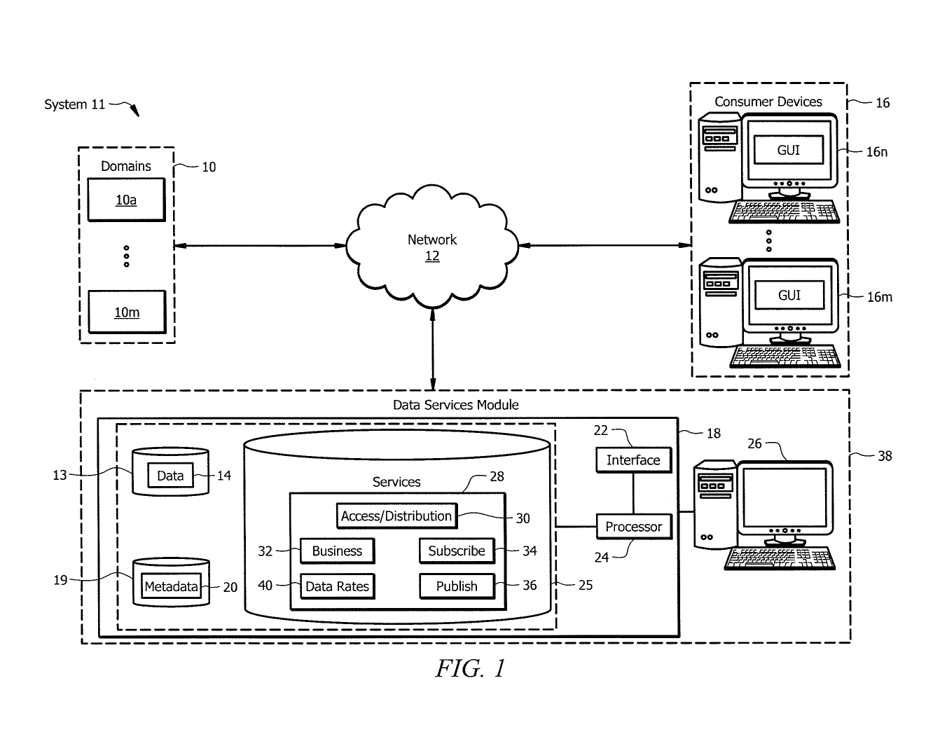

Embodiments of the present invention and its advantages are best understood by referring to FIGS. 1-4, like numerals being used for like and corresponding parts of the various drawings.

Enterprises may create and store data across multiple sources. Each source may represent a domain. Multiple consumers may request data from one or more of these domains. In conventional systems, each consumer unilaterally requests data from one or more domains. Thus, data must be extracted from the one or more domains with each individual consumer request.

To facilitate transferring data, a data service may extract data from each domain, and the data is held by a data services module. Consumers may then receive data from the data services module. This increases efficiencies by decreasing the number of times data must be extracted from the domains. Furthermore, this leads to a more efficient and transparent data supply chain. Additionally, the teachings of this disclosure provide for greater efficiencies in computer resources and network usage.

FIG. 1 illustrates a system for a file movement service. More specifically, system 11 includes domains 10, consumer devices 16, computer 26, enterprise 38, and data services module 18 that may be coupled by network 12. Generally, data services module 18 retrieves data from domains 10 and communicates data to consumer devices 16.

System 11 may include domains 10a-10n, where n represents any suitable number. Domains 10 may be located within enterprise 38 or any other suitable location where domains 10 can communicate with enterprise 38, data services module 18, computer 26, consumer devices 16, any other suitable component of system 11, or any combination of the preceding. Domains 10 represent any source of information that may be used by data services module 18. Domains 10 may include a device (such as a database, a personal computer, a workstation, a laptop, a wireless or cellular telephone, an electronic notebook, a personal digital assistant, or any other device capable of receiving, processing, storing, and/or communicating information), a person (such as a person who has knowledge of an entity and who provides such knowledge for communication to data services module 18), one or more documents (such as a spreadsheet that contains data), the Internet (which may include articles and other information containing data), an open source intelligence report, a media outlet such as a television station or a radio station that broadcasts information that may be communicated to data services module 18), any other suitable source of information, or any combination of the preceding. Domains 10 may include any one or a combination of volatile or non-volatile local or remote devices suitable for storing information. For example, domains 10 may include Random Access Memory (“RAM”), Read-only Memory (“ROM”), magnetic storage devices, optical storage devices, or any other suitable information storage device or combination of these devices. Domains 10 may comprise data pertaining to customers, consumer deposits, consumer credit cards, home loans, mortgages, automobile loans, small business credit cards, products, any other suitable type of financial data, any other suitable type of data, or any combination of the preceding.

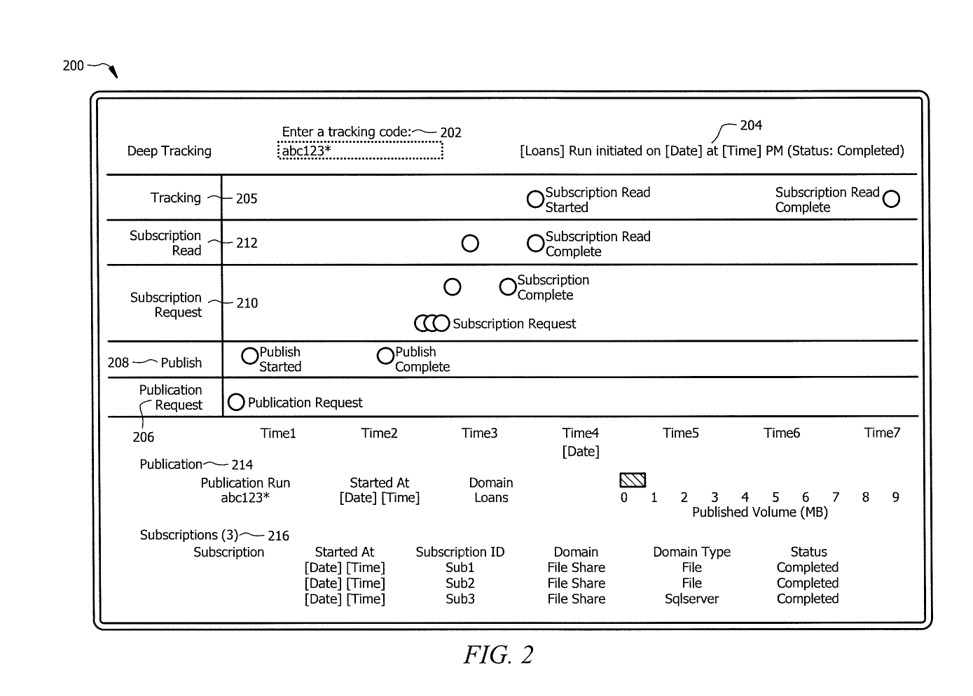

System 11 includes consumer devices 16a-16m, where m represents any suitable number. Consumer devices 16 may be located remote to enterprise 38 or any other location that allows for consumer devices 16 to communicate with enterprise 38, data services module 18, computer 26, or any other suitable component of system 11. Consumer devices 16 may request data from domains 10. Consumer devices 16 may represent computers comprising a graphical user interface (such as the graphical user interface described in reference to FIG. 2). Consumer devices 16 may be internal or external to enterprise 38. Consumer devices 16 may reside within a bank, a bank division, any other financial institution, or any other entity which may request data from domains 10. In an embodiment, consumer devices 16 comprise a risk division, a financial division, and a compliance division within a financial institution.

Consumer devices 16 may include a network service, any suitable remote service, a mainframe, a host computer, a workstation, a web server, a personal computer, a file server, or any other suitable device operable to communicate with enterprise 38, data services module 18, domains 10, computer 26, or any combination of the preceding. In some embodiments, consumer devices 16 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of consumer devices 16 may be performed by any suitable combination of one or more servers or other components at one or more locations. In the embodiment where the modules are servers, the servers may be public or private servers, and each server may be a virtual or physical server. The server may include one or more servers at the same or at remote locations. Also, consumer devices 16 may include any suitable component that functions as a server.

Network 12 facilitates communications between domains 10, enterprise 38, data services module 18, consumer devices 16, and computers 26. This disclosure contemplates any suitable network 12 operable to facilitate communication between the components of system 11. Network 12 may include any interconnecting system capable of transmitting audio, video, signals, data, messages, or any combination of the preceding. Network 12 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components of system 11. This disclosure contemplates end networks having one or more of the described properties of network 12.

System 11 includes enterprise 38. Enterprise 38 may refer to a financial institution, such as a bank. Enterprise 38 facilitates communicating information to consumer devices 16 and receiving information from domains 10. In particular, enterprise 38 may facilitate communicating data to consumer devices 16. Even though enterprise 38 is referred to as a financial institution, enterprise 38 may include any suitable type of entity in any suitable industry.

Enterprise 38 may include data services module 18 and computer 26. Data services module 18 represents any suitable component that receives data from domains 10 and communicates data to consumer devices 16. Data services module 18 may include a network service, any suitable remote service, a mainframe, a host computer, a workstation, a web server, a personal computer, a file server, or any other suitable device operable to communicate with domains 10, consumer devices 16, computer 26, or any other suitable component of system 11 via network 12. In some embodiments, data services module 18 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. The functions of data services module 18 may be performed by any suitable combination of one or more servers or other components at one or more locations. In the embodiment where the modules are servers, the servers may be public or private servers, and each server may be a virtual or physical server. The server may include one or more servers at the same or at remote locations. Also, data services module 18 may include any suitable component that functions as a server.

In the illustrated embodiment, data services module 18 includes interface 22, processor 24, memory 25, database 13, and database 19. Interface 22 represents any suitable device operable to receive information from network 12, transmit information through network 12, perform suitable processing of the information, communicate to other devices, or any combination of the preceding. For example, interface 22 transmits data 14 to one or more consumer devices 16. As another example, interface 22 receives data 14 from one or more domains 10. Interface 22 represents any port or connection, real or virtual, including any suitable hardware and/or software, including protocol conversion and data processing capabilities, to communicate through a LAN, WAN, or other communication systems that allows data services module 18 to exchange information with network 12, domains 10, enterprise 38, computer 26, consumer devices 16, and other components of system 11.

Processor 24 controls the operation and administration of data services module 18 by processing information received from interface 22, memory 25, data 14, metadata 20, any other suitable component of system 11, or any combination of the preceding. Processor 24 communicatively couples to interface 22, memory 25, database 13, and database 19. Processor 24 includes any hardware and/or software that operates to control and process information. For example, processor 24 may be a programmable logic device, a microcontroller, a microprocessor, any suitable processing device, or any suitable combination of the preceding.

Memory 25 may be a database that stores, either permanently or temporarily, services 28. In the illustrated embodiment, services 28 includes access/distribution rules 30, business rules 32, subscribe rules 34, publish rules 36, any other suitable data, or any combination of the preceding. Memory 25 includes any one or a combination of volatile or non-volatile local or remote devices suitable for storing information. For example, memory 25 may include RAM, ROM, magnetic storage devices, optical storage devices, or any other suitable information storage device or combination of these devices. Memory 25 may include any suitable information for use in the operation of data services module 18. Additionally, memory 25 may be a component external to data services module 18. Memory 25 may be located in data services module 18, enterprise 38, or any other location suitable for memory 25 to communicate with data services module 18.

Memory 25 may include access/distribution rules 30. Access/distribution rules 30 generally refer to logic, rules, algorithms, code, tables, and/or other suitable instructions embodied in a computer-readable storage medium for performing the described functions and operations of data services module 18. For example, access/distribution rules 30 facilitate communicating data to consumer devices 16. In an embodiment, data 14 may require limited access. For example, data 14 may contain confidential information. In this embodiment, access/distribution rules 30 facilitate providing data 14 only to approved consumer devices 16. In another example, consumer device 16 may request data 14 at a particular time of day. Access/distribution rules 30 facilitate communicating data 14 to consumer devices 16 at the requested times. As another example, consumer devices 16 may request data 14 in a certain format (e.g., a report in a certain format). Access/distribution rules 30 facilitate transforming data 14 into the requested format. While illustrated as including a particular module, access/distribution rules 30 may include any suitable information for use in the operation of data services module 18.

Memory 25 may include business rules 32. Business rules 32 generally refer to logic, rules, algorithms, code, tables, and/or other suitable instructions embodied in a computer-readable storage medium for performing the described functions and operations of data services module 18. For example, business rules 32 facilitate cross domain use. One or more consumer devices 16 may want to receive data originating from two or more domains 10. Business rules 32 may facilitate combining data from two or more domains. For example, business rules 32 may facilitate collecting mortgage data with customer data and deposit data. Data services module 18 may then communicate the combined data to one or more consumer devices 16. While illustrated as including a particular module, business rules 32 may include any suitable information for use in the operation of data services module 18.

Memory 25 may include subscribe rules 34. Subscribe rules 34 generally refer to logic, rules, algorithms, code, tables, and/or other suitable instructions embodied in a computer-readable storage medium for performing the described functions and operations of data services module 18. Subscribe rules 34 may facilitate communicating data to one or more consumer devices 16. For example, a consumer device 16 may request data 14 and request to receive updated data 14 at a certain interval (e.g., every hour). In this example, subscribe rules 34 may facilitate communicating the requested data 14 at the particular interval. While illustrated as including a particular module, subscribe rules 34 may include any suitable information for use in the operation of data services module 18.

Memory 25 may include data rules 40. Data rules 40 generally refer to logic, rules, algorithms, code, tables, and/or other suitable instructions embodied in a computer-readable storage medium for performing the described functions and operations of data services module 18. For example, data rules 40 may facilitate transforming data into a common format before storing the data in data 14. For example, each domain 10 may comprise data in a different format. To avoid complications with storing data in different formats, data rules 40 may facilitate transforming the data into a standard format. In another example, data rules 40 may facilitate compressing data extracted from domains 10. In this example, data rules 40 may compress the data extracted from domains 10 using one or more compression algorithms. This allows for data compression to be standardized across system 11. As an additional example, consumer device 16 may want to receive a hard copy of data. In this embodiment, data rules 40 may facilitate printing and mailing data to one or more consumer devices 16. For example, system 11 may print data 14 using a laser printer. In an embodiment, data rules 40 may facilitate determining whether data contained in domains 10 has been updated or modified. If the data has been updated or modified, data services module 18 may extract the updated data (and associated metadata). While illustrated as including a particular module, data rules 40 may include any suitable information for use in the operation of data services module 18.

Memory 25 may include publish rules 36. Publish rules 36 generally refer to logic, rules, algorithms, code, tables, and/or other suitable instructions embodied in a computer-readable storage medium for performing the described functions and operations of data services module 18. Publish rules 36 may facilitate retrieving data from one or more domains 10 and storing the data in database 13. For example, consumer devices 16 may often request certain data fields in domains 10. Publish rules 36 may preemptively facilitate extracting those data fields and storing the data fields as data 14. In another example, publish rules 36 may extract certain data fields from domains 10 based on a request from a consumer device 16. While illustrated as including a particular module, publish rules 36 may include any suitable information for use in the operation of data services module 18.

Data services module 18 may include database 13. Database 13 may be a database that stores, either permanently or temporarily, data fields retrieved from domains 10, including data 14. Database 13 includes any one or a combination of volatile or non-volatile local or remote devices suitable for storing information. For example, database 13 may include RAM, ROM, magnetic storage devices, optical storage devices, or any other suitable information storage device or combination of these devices. Additionally, database 13 may be a component external to data services module 18. Database 13 may be located in data services module 18, enterprise 38, or any other location suitable for memory 25 to communicate with data services module 18. In an embodiment, database 13 may be a commodity-based hardware platform. This increases efficiencies as a commodity-based hardware platform may provide memory at a relatively low cost.

Database 13 may include data 14. Generally, data 14 may comprise data for consumption by consumer devices 16. For example, data 14 may comprise data pertaining to customers, consumer deposits, consumer credit cards, home loans, mortgages, automobile loans, small business credit cards, products, any other suitable type of financial data, any other suitable type of data, or any combination of the preceding.

Data services module 18 may include database 19. Database 19 may be a database that stores, either permanently or temporarily, data fields retrieved from domains 10, including metadata 20. Database 19 includes any one or a combination of volatile or non-volatile local or remote devices suitable for storing information. For example, database 19 may include RAM, ROM, magnetic storage devices, optical storage devices, or any other suitable information storage device or combination of these devices. Additionally, database 19 may be a component external to data services module 18. Database 19 may be located in data services module 18, enterprise 38, or any other location suitable for memory 25 to communicate with data services module 18. In an embodiment, database 19 is located external to database 13. Additionally, database 19 may be a commodity-based hardware platform. This increases efficiencies as a commodity-based hardware platform may provide memory at a low cost.

Database 19 may include metadata 20. Generally, metadata 20 comprises information that describes data 14. Metadata 20 may describe the contents and context of data 14. Metadata 20 may be used to facilitate determining the characteristics of data 14. For example, metadata 20 may provide information that helps track changes to data 14. Metadata 20 may indicate, where data 14 originated and which consumer devices 16 received data 14. This facilities data supply chain transparency. For example, if data 14 is sensitive data, metadata 20 may facilitate completing an audit report to indicate that the sensitive data was not mishandled.

In the illustrated embodiment, enterprise 38 includes computer 26. Computer 26 may be any device that interacts with system 11. For example, computer 26 may interact with data services module 18 or domains 10 via network 12 to extract data. As another example, computer 26 may facilitate adding or modifying rules associated with data services module 18 (e.g., the rules stored in memory 25). In another example, computer 26 may interact with consumer devices 16 via network 12 to facilitate data communication. Computer 26 may use a processor and a memory to execute and to perform any of the functions described herein. Computer 26 may be a personal computer, a workstation, a laptop, a wireless or cellular telephone, an electronic notebook, a personal digital assistant, a tablet, or any other device (wireless, wireline, or otherwise) capable of receiving, processing, storing, and/or communication information with other components of system 11, or any combination of the preceding. Computer 26 may also include a user interface, such as a display, a touchscreen, a microphone, keypad, or other appropriate terminal equipment usable by a user.

A component of system 11 may include an interface, logic, memory, and/or other suitable element. An interface receives input, sends output, processes the input and/or output, and/or performs other suitable operations. An interface may comprise hardware and/or software. Logic performs the operations of the component. For example, logic executes instructions to generate output from input. Logic may include hardware, software, and/or other logic. Logic may be encoded in one or more non-transitory, tangible media, such as a computer readable storage medium or any other suitable tangible medium, and may perform operations when executed by a computer. Certain logic, such as a processor, may manage the operation of a component. Examples of a processor include one or more computers, one or more microprocessors, one or more applications, and/or other logic.

To better understand the functions of system 11, an example of file movement services will be used. However, it is understood that system 11 may be used in a variety of contexts and areas to allow domains 10, consumer devices 16, enterprise 38, computer 26, and data services module 18 to communicate data in an efficient and transparent manner.

In one exemplary embodiment of operation, data services module 18 receives a request for data services from one or more consumer devices 16. Consumer devices 16 may comprise a graphical user interface (such as the graphical user interface illustrated in FIG. 2) to facilitate submitting a request for data services. The data services request may indicate particular data. The data services request may indicate that the data be provided in a particular format. The data services request may also request that data be provided at a particular time. Furthermore, the data services request may include a subscription to the data (e.g., requesting the data at certain intervals).

Data services module 18 may determine whether the data requested by consumer device 16 is within data 14. For example, data services module 18 may have previously extracted the requested data from domains 10 for a consumer device 16 or may have preemptively extracted the requested data. If the requested data is within data 14, data services module 18 may communicate the requested data to consumer devices 16 in accordance with the data services request.

If the requested data is not within data 14, data services module 18 may communicate with domains 10 to extract the requested data before communicating the data to the consumer device 16. Once the requested data has been extracted, data services module 18 may compress the data, encrypt the data, and/or transform the data into a standard format before storing the data as data 14. An advantage of this disclosure includes extracting only requested data. For example, domains 10 may include data that consumer devices 16 do not submit a request to receive. Data services module 18 may only extract data that consumer devices 16 request or are likely to request. Data services module 18 may also extract metadata associated with the extracted data. Data services module 18 may then communicate the data to consumer devices 16 in accordance with the data services request.

In an embodiment, the data services request may include a request for metadata 20 associated with data 14. In this embodiment, data services module 18 may communicate metadata 20 to the consumer devices 16 in a similar manner as described above. In yet, another embodiment, computer 26 may request and retrieve data 14 and/or metadata 20 in a similar manner as described above.

Modifications, additions, or omissions may be made to system 11 without departing from the scope of the disclosure. For example, system 11 may include any number of data services modules 18, external modules 16, data sources 10, enterprises 38, or computers 26. Furthermore, the components of system 11 may be integrated or separated. For example, data services module 18 and data sources 10 may be incorporated into a single component.

FIG. 2 illustrates an example graphical user interface for facilitating a file movement service. In an embodiment, a user utilizes graphical user interface 200 to interact with system 11. Graphical user interface 200 may be displayed on one or more consumer devices 16, computer 26, or any other suitable component of system 11. In the illustrated embodiment, graphical user interface 200 comprises tracking code 202, progress bar 204, tracking pane 205, publication results 214, and subscriptions field 216. Tracking code 202 facilitates tracking data. As described, metadata 20 may be used to determine the characteristics of data 14. For example, metadata 20 may provide information that helps track changes to data 14. Metadata 20 may indicate where data 14 originated and which consumer devices 16 received data 14. This improves data supply chain transparency. For example, if data 14 is sensitive data, metadata 20 may provide information that helps complete an audit report to indicate that the sensitive data was handled appropriately. Tracking code 202 may be applied to a dataset to link metadata 20 to the dataset, thus allowing a user to determine information about certain data 14.

Graphical user interface 200 may comprise progress bar 204. As illustrated, progress bar 204 indicates when a run is initiated and the status of the run. For example, when a user may request data by initiating a run. Progress bar 204 may indicate the date and time the user requested the data 14 and whether the request has been completed.

In the illustrated embodiment, graphical user interface 200 comprises tracking pane 205. Generally, tracking pane 205 provides information regarding when a user requests or receives information related to data 14 and/or metadata 20. For example, tracking pane 205 may comprise publication request field 206, publish field 208, subscription request field 210, and subscription read field 212. Publication request field 206 may indicate when a user requests certain data. The request may comprise data within one or more domains 10, database 13, and/or database 19. If the request is for data within domains 10, data services module 18 may extract the data as, previously discussed. The time of retrieval is illustrated in publish field 208. Subscription request field 210 may indicate a time that one or more consumer devices 16 subscribes to data 14 and/or metadata 20. As described, a user may request to receive data 14 and/or metadata 20 multiple times. Subscription request field 210 may include information regarding when a request for subscription is made. Subscription read field 212 may include information regarding when a user views data 14 and/or metadata 20 that is associated with a particular subscription.

Graphical user interface 200 may comprise publication field 214. In general, publication field 214 provides information related to data 14 and/or metadata 20. In an embodiment, publication field 214 indicates information associated with data services module 18 extracting data from domains 10. In the illustrated embodiment, publication field 214 indicates when data services module 18 extracted data, from what domain(s) the data was extracted, and the size of the data extracted.

In the illustrated embodiment, graphical user interface 200 comprises subscriptions field 216. Subscriptions field 216 indicates data 14 and/or metadata 20 subscribed to by consumer device 16. Subscriptions field 216 may allow consumer devices 16, computer 26, enterprise 38, or any other suitable component of system 11 to determine data 14 and/or metadata 20 consumer 216 is subscribed. In the illustrated embodiment, subscriptions field 216 includes a subscription identification, the last extraction time of data 14 and/or metadata 20, the domain and domain type of the domain 10, and the status of the data extraction.

Modifications, additions, or omissions may be made to graphical user interface 200 without departing from the scope of the disclosure. For example, graphical user interface 200 may display more, fewer, or other information. Additionally, graphical user interface 200 may receive more, fewer, or other inputs. For example, graphical user interface 200 may indicate if data 14 has been modified. As an additional example, graphical user interface 200 may receive as input a request for data 14 to be provided in a particular format.

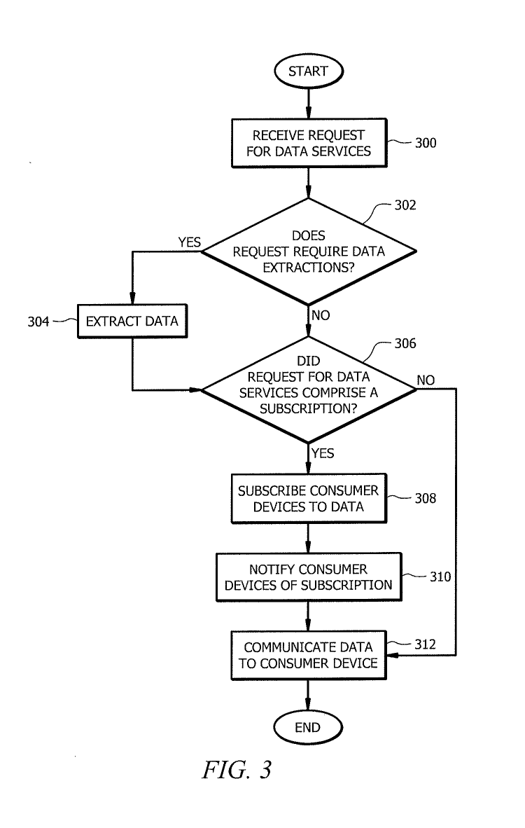

FIG. 3 illustrates an example method for providing data services to consumer devices 16. The method begins at step 300 where data services module 18 receives a request for data services. Consumer devices 16 may generate a request for data services and communicate the request to data services module 18. In an embodiment, a user may utilize a graphical user interface associated with consumer devices 16 to generate a request for data services. A request for data services may comprise a request to receive particular data. The request for data services may also include a request to receive data in a certain format, at a certain time, or at a certain interval on an ongoing basis.

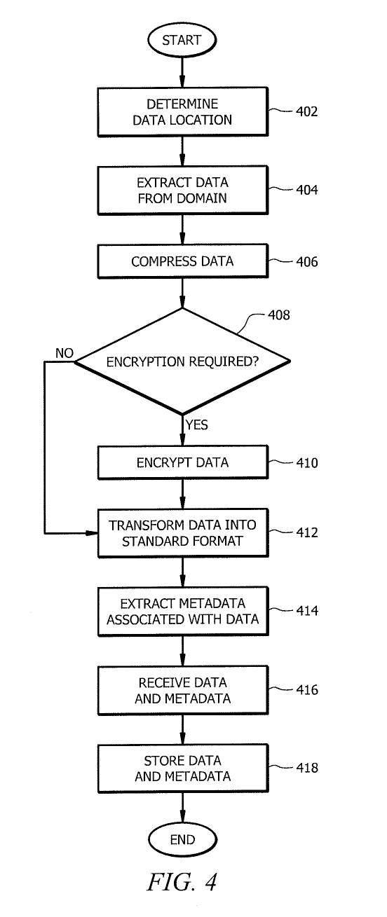

At step 302, data services module 18 determines whether the data services request requires data extraction. Data services module 18 may have already extracted data from domains 10 to respond to a previous request for data services. Additionally, data services module 18 may have determined, using publish rules 36, that one or more consumer devices 16 were likely to request data. In this embodiment, data services module 18 may have preemptively extracted the data base on, for example data rules 40. If data services module 18 determines that the requested data is not currently available in database 13 and request requires data extraction, the method proceeds to step 304 where data services module 18 extracts data from one or more domains 10. Step 304 is discussed in more detail with reference to FIG. 4.

If data services module 18 determines that the request does not require data extraction, the method proceeds to step 306 where data services module 18 determines whether the request for data services comprises a request to subscribe to data. For example, consumer device 16 may request to receive updated data 14 at a certain interval (e.g., once a quarter). If the request does comprise a subscription request, the method proceeds to step 308; otherwise, the method proceeds to step 312 where the data is communicated consumer device 16. At step 308, data services module 18 subscribes consumer device 16 to the data 14. In an embodiment, data services module 18 may extract updated data 14 from domains 10 and communicate the updated data 14 to one or more consumer devices 16 at particular intervals. For example, data rules 40 may facilitate determining whether extracted data from domains 10 has been updated or modified. If the data has been updated or modified, data services module 18 may extract the updated data (and associated metadata) as described in more detail in FIG. 4. Next, the method proceeds to step 310 where data services module 18 notifies the consumer device 16 that it is subscribed to the data 14.

At step 312, data services module 18 communicates the data to the consumer device 16. The request for data services may comprise a request to receive data 14 in a particular format. Data services module 18 may transform the data 14 into the particular format before communicating the data to the consumer. After completing step 312, the method ends.

Modifications, additions, or omissions may be made to the method depicted in FIG. 3. The method may include more, fewer, or other steps. For example, data services module 18 may communicate metadata 20 to one or more consumer devices 16. As another example, data services module may combine multiple datasets within data 14 before communicating data to consumer devices 16. As yet another example, steps may be performed in parallel or in any suitable order. While discussed as data services module 18 performing the steps, any suitable component of system 11 may perform one or more steps of the method.

FIG. 4 illustrates an example method for extracting data from domains 10 as illustrated in step 304 of FIG. 3. The method begins at step 402 where data services module 18 determines the data location. For example, data services module 18 may determine which domain(s) 10 contain the requested data and where within the domain(s) 10 the requested data is located. The request for data services may indicate the location of the requested data. As another example, data rules 40 may determine the location of the requested data.

At step 404, data services module 18 extracts the requested data from one or more domains 10. Data services module 18 may only extract the data identified in the request for data services. As another example, data services module 18 may extract data that it has determined (e.g., using data rules 40) consumer devices 16 may request. This increases efficiency as only data that is requested or likely to be requested is extracted from domains 10.

Data services module 18 determines whether the requested data requires encryption at step 408. For example, if requested data is sensitive or confidential, enterprise 38, federal regulations, or any other source may require the requested data be encrypted. If the requested data does not require encryption, the method proceeds to step 412. If the requested data does require encryption, the method proceeds to step 410 where data services module 18 encrypts the requested data. In an embodiment, data services module 18 applies a uniform encryption algorithm to all data extracted from domains 10. This allows data across system 11 to be encrypted using a standard encryption algorithm. Next, the method proceeds to step 412.

At step 412, data services module 18 transforms the extracted data into a standard format. For example, each domain 10 may comprise data in a different format. To avoid complications with storing data in different formats, data rules 40 may facilitate transforming the extracted data into a standard format.

The method then proceeds to step 414 where data services module extracts metadata from domains 10. Metadata may describe the content and context of the extracted data. Metadata may be used to help determine the characteristics of the extracted data. For example, metadata may provide information that helps track changes to the extracted data. Metadata may indicate where the extracted data originated and which consumer devices 16 received data. This improves data supply chain transparency. For example, if data is sensitive data, metadata may be used to complete an audit report to indicate that the sensitive data was handled appropriately.

At step 416, data services module 18 receives the extracted data and metadata. For example, interface 22 may receive the extracted data and metadata. Next, data services 18 stores the extracted data and metadata as data 14 and metadata 20 before the method ends.

Modifications, additions, or omissions may be made to the method depicted in FIG. 4. The method may include more, fewer, or other steps. For example, data services module 18 may not extract metadata. As another example, data services module 18 may not compress the extracted data. As another example, data services module 18 may not transform the extracted data into a standard format. As yet another example, the steps may be performed in parallel or in any suitable order. While discussed as data services module 18 performing the steps, any suitable component of system 11 may perform one or more steps of the method.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system, comprising:
an interface operable to receive a request for data services from a consumer, wherein the consumer comprises one of a financial institution and a credit bureau and the request for data services comprises at least one of a request for financial data and a request for metadata;
a processor communicatively coupled to the interface and operable to:
determine whether the request requires data publication;
when the request requires data publication:
extract data from one of a plurality of domains, wherein the domain stores the data and metadata associated with the financial institution;
automatically transform the data into a standard format;
automatically extract metadata associated with the data; and
automatically receiving the data and the metadata from the interface;
a memory communicatively coupled to the processor and operable to automatically store the data and the metadata, wherein the data and the metadata are stored separately;
the processor further operable to link the consumer with the data; and
the interface further operable to communicate the data to the consumer.

2. The system of claim 1, wherein the interface is further operable to communicate the metadata to the consumer, the metadata providing information related to the data and the information comprises:
the consumer that requested the data;
the location of the data within the financial institution; and
each consumer who received the data.

3. The system of claim 1, wherein the data publication further comprises encrypting the data, the encryption standardized for each consumer requesting data services.

4. The system of claim 1, wherein the data services request comprises a request to receive the data in a first format and the processor automatically transforms the data into the first format.

5. The system of claim 1, wherein the data services request comprises a request to receive the data at a predetermined interval.

6. The system of claim 1, wherein the processor automatically determines whether information within the domain is updated and, when the information is updated, dynamically updating the published data.

7. The system of claim 1, wherein the published data comprises data received from two or more of the plurality of domains.

8. A method, comprising:
receiving, through an interface, a request for data services from a consumer, wherein the consumer comprises one of a financial institution and a credit bureau and the request for data services comprises at least one of a request for financial data and a request for metadata;
determining, by a processor, whether the request requires data publication;
when the request requires data publication:
extracting data, by the processor, from one of a plurality of domains, wherein the domain stores the data and metadata associated with the financial institution;
automatically transforming, by the processor, the data into a standard format;
automatically extracting, by the processor, the metadata associated with the data;
automatically receiving, through the interface, the data and the metadata; and
automatically storing, in a memory, the data and the metadata, wherein the data and the metadata are stored separately;
linking, by the processor, the consumer with the data; and
communicating, through the interface, the data to the consumer.

9. The method of claim 8, wherein the interface is further operable to communicate the metadata to the consumer, the metadata providing information related to the data and the information comprises:
the consumer that requested the data;
the location of the data within the financial institution; and
each consumer who received the data.

10. The method of claim 8, wherein the data publication further comprises encrypting the data, the encryption standardized for each consumer requesting data services.

11. The method of claim 8, wherein the data services request comprises a request to receive the data in a first format and the processor automatically transforms the data into the first format.

12. The method of claim 8, wherein the data services request comprises a request to receive the data at a predetermined interval.

13. The method of claim 8, wherein the processor automatically determines whether information within the domain is updated and, when the information is updated, dynamically updating the published data.

14. The method of claim 8, wherein the published data comprises data received from two or more of the plurality of domains.

15. Non-transitory computer readable medium comprising logic, the logic, when executed by a processor, operable to:
receive a request for data services from a consumer, wherein the consumer comprises one of a financial institution and a credit bureau and the request for data services comprises at least one of a request for financial data and a request for metadata;
determine whether the request requires data publication;
when the request requires data publication:
extract data from one of a plurality of domains, wherein the domain stores the data and metadata associated with the financial institution;
automatically transform the data into a standard format;
automatically extract the metadata associated with the data;
automatically receive the data and the metadata; and
automatically store the data and the metadata, wherein the data and the metadata are stored separately;
link the consumer with the data; and
communicate the data to the consumer.

16. The computer readable medium of claim 15, wherein the logic is further operable to communicate the metadata to the consumer, the metadata providing information related to the data and the information comprises:
the consumer that requested the data;
the location of the data within the financial institution; and
each consumer who received the data.

17. The computer readable medium of claim 15, wherein the data publication further comprises encrypting the data, the encryption standardized for each consumer requesting data services.

18. The computer readable medium of claim 15, wherein the data services request comprises a request to receive the data in a first format and the logic is further operable to automatically transforms the data into the first format.

19. The computer readable medium of claim 15, wherein the data services request comprises a request to receive the data at a predetermined interval.

20. The computer readable medium of claim 15, wherein the logic is further operable to automatically determine whether information within the domain is updated and, when the information is updated, dynamically updating the published data.

21. The computer readable medium of claim 15, wherein the published data comprises data received from two or more of the plurality of domains.
